(19) United States
(12) Patent Application Publication
(10) Pub. No.: US 2024/0003029 A1
(43) Pub. Date: Jan. 4, 2024

(54) ZINC PRODUCTION METHOD

(71) Applicant: Kinotech Corporation, Chuou-Ku, Tokyo (JP)

(72) Inventors: Masaaki Iosaki, Chuou-Ku, Tokyo (JP); Yoshie Tamai, Chuou-Ku, Tokyo (JP); Kenji Haiki, Chuou-Ku, Tokyo (JP)

(73) Assignee: Kinotech Corporation, Chuou-Ku, Tokyo (JP)

(21) Appl. No.: 18/039,888

(22) PCT Filed: Dec. 2, 2021
(86) PCT No.: PCT/JP2021/044314

§ 371 Date: Jun. 1, 2023

(30) Foreign Application Priority Data
Dec. 4, 2020 (JP) 2020-202012

(51) Int. Cl. C25C 1/16; C25C 7/06

(52) U.S. Cl. CPC C25C 1/16; C25C 7/06

(57) ABSTRACT

A zinc production method further includes chlorine-concentration adjusting processes 101, 101′, and 105 of using an alkali hydroxide aqueous solution as an extraction solvent for selectively extracting zinc components in a zinc-containing aqueous-solution generating process 102, and separating chlorine components contained in electric arc furnace dust or secondary dust to decrease the chlorine concentration of a zinc-containing aqueous solution at a stage prior to an electrolyzing process 103.

### TECHNICAL FIELD

The present invention relates to a zinc production method, and more particularly to a zinc production method using, as a material, electric arc furnace dust generated at the time of melting and smelting of scraps in electric furnace steelmaking that is one of iron and steel making processes, and also so-called secondary dust such as secondary dust (crude zinc oxide) generated in a reduction furnace when a part of the electric arc furnace dust is recycled as a zinc material or secondary dust (crude zinc oxide) obtained by collecting blast-furnace dust generated in blast-furnace steelmaking that is one of the iron and steel making processes as zinc-containing oxide in a rotary hearth furnace.

### BACKGROUND ART

In the electric furnace steelmaking that is one of the iron and steelmaking processes, electric arc furnace dust being industrial wastes that are equivalent to about 1.5% to 2.0% of the amount of manufactured steel and that contain zinc oxide components is generated at the time of melting and smelting of scraps. It is said that eight million tons of electric arc furnace dust are generated in the world and that four hundred thousand tons are generated in Japan.

Many of iron scraps are discarded constructions, discarded home appliances, and discarded automobiles. Paint bases of discarded constructions, discarded home appliances, and discarded automobiles are plated with zinc. Furthermore, the scraps contain paint, plastic, oil, and the like. Therefore, the electric arc furnace dust also contains hazardous organics such as chloride, dioxins, and dioxin-like compounds in addition to heavy metals such as zinc or lead. Meanwhile, the electric arc furnace dust contains about 20 to 30% of iron and 20 to 30% of zinc. The crude zinc oxide contains about 10% of iron and about 60% of zinc. Accordingly, the electric arc furnace dust and the secondary dust (crude zinc oxide) are highly useful as resources.

Under such circumstances, Patent Document 1 relates to a zinc-metal production method, and discloses a configuration including a process of generating a zinc-containing aqueous solution containing zinc components using, as a material, electric arc furnace dust or secondary dust generated when electric arc furnace dust is reduced in a reduction furnace, a process of generating refined zinc chloride containing purified zinc chloride by chlorinating the zinc components of a zinc-containing compound, where the zinc components in the zinc-containing aqueous solution are the zinc-containing compound having at least one form of carbonate, hydroxide, and oxide, and a process of generating anhydrous molten refined zinc chloride containing anhydrated molten refined zinc chloride by anhydrating the refined zinc chloride, and a process of generating zinc metal as an electrolytic product by electrolyzing the anhydrous molten refined zinc chloride.

### PRIOR ART DOCUMENT

### Patent Document

Patent Document 1: Japanese Patent Application Laid-open No. 2019-119895

### SUMMARY OF THE INVENTION

### Problem to be Solved by the Invention

However, according to the studies made by the present inventors, in the configuration disclosed in Patent Document 1, a filtrate obtained in the process of generating refined zinc chloride is repeatedly used as an alkaline agent for selectively extracting zinc components from the electric arc furnace dust or the secondary dust, and chlorine gas that is obtained as a by-product in the process of generating zinc metal as an electrolytic product by electrolyzing the anhydrous molten refined zinc chloride is repeatedly used as a chloridizing agent for generating the refined zinc chloride. However, any disclosure or suggestion on aqueous solution electrolysis using the zinc-containing aqueous solution as an electrolytic bath is not provided. Furthermore, any disclosure or suggestion on repeated use of a tailing electrolyte resulting from electrolysis in the process of generating the zinc-containing aqueous solution is not provided.

Particularly, according to the studies made by the present inventors, when the zinc components in the electric arc furnace dust or the secondary dust are selectively extracted as a zinc-containing aqueous solution using an alkali hydroxide aqueous solution as an extraction solvent, the zinc-containing aqueous solution is electrolyzed to obtain zinc as an electrolytic product, and the resultant tailing electrolyte is returned as it is into the alkali hydroxide aqueous solution functioning as the extraction solvent, there is room for improvement in that the amount of chlorine components in the zinc-containing aqueous solution or the tailing electrolyte is increased to increase the chlorine concentration, which provides an unwanted impact on the characteristics of the alkali hydroxide aqueous solution functioning as the extraction solvent and provides an unwanted impact on the characteristics of zinc being the electrolytic product.

The present invention has been achieved through the above studies, and an object of the present invention is to provide a zinc production method that can decrease the chlorine concentration in processes when zinc components in electric arc furnace dust or secondary dust are selectively extracted as a zinc-containing aqueous solution using an alkaline hydroxide aqueous solution as an extraction solvent, and the zinc-containing aqueous solution is electrolyzed to produce zinc being an electrolytic product.

### Means for Solving the Problem

In order to achieve the above object, a zinc production method according to a first aspect of the present invention comprises: a zinc-containing aqueous-solution generating step of using, as a material, electric arc furnace dust or secondary dust generated when the electric arc furnace dust is reduced in a reduction furnace, and selectively extracting zinc components in the material to generate a zinc-containing aqueous solution containing the zinc components; and an electrolyzing step of performing electrolysis using the zinc-containing aqueous solution as an electrolyte to generate zinc and returning a tailing electrolyte that is the electrolyte having been subjected to the electrolysis to the zinc-containing aqueous-solution generating step, wherein an alkali hydroxide aqueous solution is used as an extraction solvent for selectively extracting the zinc components in the zinc-containing aqueous-solution generating step, and a chlorine-concentration adjusting step of separating chlorine components contained in the electric arc furnace dust or the secondary dust to decrease a chlorine concentration of the zinc-containing aqueous solution at a stage prior to the electrolyzing step is further included.

According to a second aspect of the present invention, in addition to the first aspect, the electric arc furnace dust or the secondary dust is washed with an alkali hydroxide aqueous solution to separate the chlorine components in the chlorine-concentration adjusting step.

According to a third aspect of the present invention, in addition to the second aspect, in the chlorine-concentration adjusting step, at a time of washing the electric arc furnace dust or the secondary dust, a pH value of slurry dust obtained by agitating the electric arc furnace dust or the secondary dust in a state immersed in the alkali hydroxide aqueous solution is adjusted to fall within a range not less than 8.5 and not more than 10.5 smaller than a pH value of the alkali hydroxide aqueous solution used in the zinc-containing aqueous-solution generating step.

According to a fourth aspect of the present invention, in addition to the third aspect, the tailing electrolyte is returned to the chlorine-concentration adjusting step and the alkali hydroxide aqueous solution in the chlorine-concentration adjusting step contains the tailing electrolyte, and the pH value of the slurry dust obtained by agitation in a state immersed in the alkali hydroxide aqueous solution containing the tailing electrolyte is adjusted in the chlorine-concentration adjusting step.

According to a fifth aspect of the present invention, in addition to the third or fourth aspect, a predetermined value in the range not less than 8.5 and not more than 10.5 smaller than the pH value of the alkali hydroxide aqueous solution used in the zinc-containing aqueous-solution generating step is set as a target value, and an amount of an alkali agent and an amount of water for obtaining the alkali hydroxide aqueous solution in the chlorine-concentration adjusting step are controlled according to a deviation between the target value and a measured value of the pH value of the slurry dust in the chlorine-concentration adjusting step.

According to a sixth aspect of the present invention, in addition to any of the first to fifth aspects, the chlorine components are separated by bringing an antichlor in contact with the zinc-containing aqueous solution in the chlorine-concentration adjusting step.

According to a seventh aspect of the present invention, in addition to any of the first to sixth aspects, a substituting step of bringing metallic zinc in contact with the zinc-containing aqueous solution generated in the zinc extracting step to reduce and deposit metallic impurity components that are more precious than zinc in the zinc-containing aqueous solution is further included, and electrolysis using the zinc-containing aqueous solution having passed through the substituting step as the electrolyte is performed in the electrolyzing step.

According to an eighth aspect of the present invention, in addition to any of the first to seventh aspects, a deironizing and demanganizing step of bringing an oxidant in contact with the zinc-containing aqueous solution generated in the zinc-containing aqueous-solution generating step to separate iron components and manganese components in the zinc-containing aqueous solution, and a substituting step of bringing metallic zinc in contact with the zinc-containing aqueous solution having passed through the deironizing and demanganizing step to reduce and deposit metallic impurity components that are more precious than zinc in the zinc-containing aqueous solution are further included, and electrolysis using the zinc-containing aqueous solution having passed through the substituting step as the electrolyte is performed in the electrolyzing step.

According to a ninth aspect of the present invention, in addition to the seventh or eighth aspect, a first zinc-containing aqueous solution, and a second zinc-containing aqueous solution having a lower chlorine concentration than that of the first zinc-containing aqueous solution are generated as the zinc-containing aqueous solution generated in the zinc-containing aqueous-solution generating step, and zinc generated by performing electrolysis using the first zinc-containing aqueous solution as an electrolyte in the electrolyzing step is used as the metallic zinc in the substituting step.

### Effect of the Invention

According to the zinc production method of the first aspect of the present invention, an alkali hydroxide aqueous solution is used as an extraction solvent for selectively extracting zinc components in a zinc-containing aqueous-solution generating step, and a chlorine-concentration adjusting step of separating chlorine components contained in electric arc furnace dust or secondary dust to decrease a chlorine concentration of a zinc-containing aqueous solution at a stage prior to an electrolyzing step is further included. Therefore, increase in the chlorine concentration of the alkali hydroxide aqueous solution, the zinc-containing aqueous solution, or a tailing electrolyte can be suppressed, and zinc having characteristics of a desired quality can be produced.

According to the zinc production method of the second aspect of the present invention, the electric arc furnace dust or the secondary dust is washed with an alkali hydroxide aqueous solution to separate the chlorine components in the chlorine-concentration adjusting step. Therefore, the chlorine components contained in the electric arc furnace dust or the secondary dust can be reliably separated at a stage prior to the zinc-containing aqueous-solution generating step to reliably suppress increase in the chlorine concentration of the alkali hydroxide aqueous solution, the zinc-containing aqueous solution, or a tailing electrolyte, and zinc having characteristics of a desired quality can be produced.

According to the zinc production method of the third aspect of the present invention, in the chlorine-concentration adjusting step, at a time of washing the electric arc furnace dust or the secondary dust, a pH value of slurry dust obtained by agitating the electric arc furnace dust or the secondary dust in a state immersed in the alkali hydroxide aqueous solution is adjusted to fall within a range not less than 8.5 and not more than 10.5 smaller than a pH value of the alkali hydroxide aqueous solution used in the zinc-containing aqueous-solution generating step. Therefore, it is possible to cause the chlorine components to elute from the electric arc furnace dust or the secondary dust without extraction of zinc components, and zinc having characteristics of a desired quality can be produced.

According to the zinc production method of the fourth aspect of the present invention, the tailing electrolyte is returned to the chlorine-concentration adjusting step and the alkali hydroxide aqueous solution in the chlorine-concentration adjusting step contains the tailing electrolyte, and the pH value of the slurry dust obtained by agitation in a state immersed in the alkali hydroxide aqueous solution containing the tailing electrolyte is adjusted in the chlorine-concentration adjusting step. Therefore, even when the tailing electrolyte is used as a part of the washing liquid, it is possible to cause the chlorine components to elute from the electric arc furnace dust or the secondary dust without further extraction of zinc components, and zinc having characteristics of a desired quality can be produced.

According to the zinc production method of the fifth aspect of the present invention, a predetermined value in the range not less than 8.5 and not more than 10.5 smaller than the pH value of the alkali hydroxide aqueous solution used in the zinc-containing aqueous-solution generating step is set as a target value, and an amount of an alkali agent and an amount of water for obtaining the alkali hydroxide aqueous solution in the chlorine-concentration adjusting step are controlled according to a deviation between the target value and a measured value of the pH value of the slurry dust in the chlorine-concentration adjusting step. Therefore, the pH value of the slurry dust can be reliably maintained at an appropriate value, and zinc having characteristics of a desired quality can be produced.

According to the zinc production method of the sixth aspect of the present invention, the chlorine components are separated by bringing an antichlor in contact with the zinc-containing aqueous solution in the chlorine-concentration adjusting step. Therefore, the chlorine components contained in the electric arc furnace dust or the secondary dust can be supplementarily separated between the zinc-containing aqueous-solution generating step and the electrolyzing step to reliably suppress increase in the chlorine concentration of the alkali hydroxide aqueous solution, the zinc-containing aqueous solution, or the tailing electrolyte, and zinc having characteristics of a desired quality can be produced.

According to the zinc production method of the seventh aspect of the present invention, a substituting step of bringing metallic zinc in contact with the zinc-containing aqueous solution generated in the zinc extracting step to reduce and deposit metallic impurity components that are more precious than zinc in the zinc-containing aqueous solution is further included, and electrolysis using the zinc-containing aqueous solution having passed through the substituting step as the electrolyte is performed in the electrolyzing step. Therefore, zinc in which mixed impurities have been decreased can be stably mass-produced at a high yield.

According to the zinc production method of the eighth aspect of the present invention, a deironizing and demanganizing step of bringing an oxidant in contact with the zinc-containing aqueous solution generated in the zinc extracting step to separate iron components and manganese components in the zinc-containing aqueous solution, and a substituting step of bringing metallic zinc in contact with the zinc-containing aqueous solution having passed through the deironizing and demanganizing step to reduce and deposit metallic impurity components that are more precious than zinc in the zinc-containing aqueous solution are further included, and electrolysis using the zinc-containing aqueous solution having passed through the substituting step as the electrolyte is performed in the electrolyzing step. Therefore, zinc in which mixed impurities have been decreased can be stably mass-produced at a high yield.

According to the zinc production method of the ninth aspect of the present invention, a first zinc-containing aqueous solution, and a second zinc-containing aqueous solution having a lower chlorine concentration than that of the first zinc-containing aqueous solution are generated as the zinc-containing aqueous solution generated in the zinc extracting step, and zinc generated by performing electrolysis using the first zinc-containing aqueous solution as an electrolyte in the electrolyzing step is used as the metallic zinc in the substituting step. Therefore, the substituting step can be efficiently performed effectively using zinc being an electrolytic product, and zinc in which mixed impurities have been decreased can be stably mass-produced at a high yield.

### BRIEF DESCRIPTION OF THE DRAWINGS

FIG. 1A is a process chart of a zinc production method according to a first embodiment of the present invention.

FIG. 1B is a process chart of generating secondary dust that can be used as a material in the zinc production method according to the present embodiment.

FIG. 2 is a process chart of a zinc production method according to a second embodiment of the present invention.

FIG. 3A is a process chart of a zinc production method according to a third embodiment of the present invention.

FIG. 3B is a diagram illustrating a micrograph of zinc generated when an electrolytic bath of a high chlorine concentration is used in the zinc production method according to the present embodiment.

FIG. 4 is a process chart of a zinc production method according to a fourth embodiment of the present invention.

FIG. 5 is a table 1 indicating a result of an experimental example of the first embodiment of the present invention.

FIG. 6 is a table 2 indicating a result of an experimental example of the second embodiment of the present invention.

FIG. 7 is a table 3 indicating a result of an experimental example of the third embodiment of the present invention.

FIG. 8 is a table 4 indicating a result of an experimental example of the fourth embodiment of the present invention.

FIG. 9A is a process chart of a zinc production method according to a fifth embodiment of the present invention.

FIG. 9B is a schematic diagram illustrating a configuration of a washer used in a chlorine-concentration adjusting process including pH adjustment in the present embodiment.

### EMBODIMENT FOR CARRYING OUT THE INVENTION

A zinc production method according to embodiments of the present invention will be explained below in detail with reference to the accompanying drawings as appropriate.

### First Embodiment

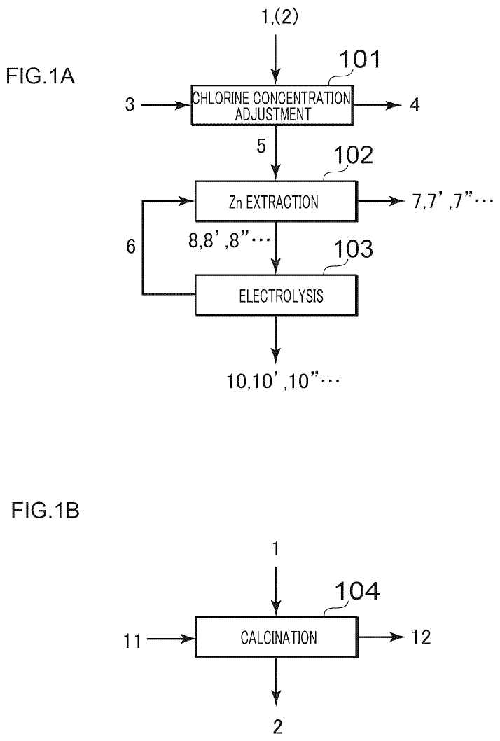

First, a zinc production method according to a first embodiment of the present invention is explained in detail with reference to FIGS. 1A and 1B.

FIG. 1A is a chart illustrating processes of the zinc production method of the present embodiment, and FIG. 1B is a process chart for generating secondary dust that can be used as a material in the zinc production method of the present embodiment.

In the present embodiment, as illustrated in FIG. 1A, a chlorine-concentration adjusting process 101, a zinc extracting process 102, and an electrolyzing process 103 are sequentially performed. The zinc extracting process 102 corresponds to a zinc-containing aqueous-solution generating process. This method is based on a production concept of prioritizing generation of an aqueous solution by extracting zinc components from electric arc furnace dust or secondary dust as a material and performing electrolysis using the aqueous solution as an electrolyte to generate zinc as an electrolytic product.

Specifically, first, in the chlorine-concentration adjusting process 101, electric arc furnace dust 1 as a material that contains a zinc-containing compound being zinc oxide or the like, and an iron compound being iron oxide or the like is washed with a washing agent 3, and chlorine components adsorbing on the electric arc furnace dust 1 are caused to elute to be separated from the electric arc furnace dust 1 to obtain washed electric arc furnace dust 5. A used washing agent 4 that is obtained by the washing of the electric arc furnace dust 1 with the washing agent 3 and that contains the eluted chlorine components having adsorbed on the electric arc furnace dust 1 may be repeatedly used as the washing agent 3 to wash the electric arc furnace dust 1 again to the extent that it enables further chlorine components to elute. A strong alkaline agent having a significant effect of enabling chlorine components to elute from the electric arc furnace dust 1 can be suitably used as the washing agent 3 and, specifically, an aqueous solution of such a strong alkaline agent can be suitably used as the washing liquid. Furthermore, from the viewpoint of using also an alkaline agent to enhance efficiency, it is more preferable to use an alkaline agent 6 that is hydroxide such as sodium hydroxide used in the zinc extracting process 102, as the washing agent 3 and, specifically, it is preferable to use an alkali hydroxide aqueous solution that is an aqueous solution of the alkali agent 6 being hydroxide such as sodium hydroxide as a washing liquid.

As a material to be washed in the chlorine-concentration adjusting process 101, secondary dust 2 obtained by reducing the electric arc furnace dust 1 in a reduction furnace may be used instead of the electric arc furnace dust 1. As a material to be washed in the chlorine-concentration adjusting process 101, in a case of adopting a calcining process 104 illustrated in FIG. 1B, secondary dust 2 obtained by mixing calcium carbonate 11 with the electric arc furnace dust 1 and calcining the resultant in the process may be used. With this calcination, zinc components contained in zinc ferrite components of the electric arc furnace dust 1 can be transformed in advance into zinc oxide components that can be easily extracted with an alkali agent in the zinc extracting process 102. In a case in which the secondary dust 2 obtained by the calcination mixing the calcium carbonate 11 is used as the material, calcium components in residues 7 obtained in the zinc extracting process 102 can be increased. Carbon dioxide 12 obtained by this calcination can be stored or used as necessary. In the calcinating process 104, with volatilization of ZnCl₂ being low-boiling components, chlorine components in the secondary dust 2 can be decreased as compared to those in the electric arc furnace dust from which the secondary dust 2 has been generated. As the material to be used in the chlorine-concentration adjusting process 101, secondary dust such as crude zinc oxide derived from the electric arc furnace dust 1 may be used. While chlorine is targeted as components to be separated from the electric arc furnace dust 1 by washing the electric arc furnace dust 1 with the washing agent 3 in the chlorine-concentration adjusting process 101, fluorine may be targeted in addition to chlorine, or instead of chlorine as the components to be separated by the same method.

Next, in the zinc extracting process 102, electric arc furnace dust 5 that has been washed in the chlorine-concentration adjusting process 101 to cause the chlorine components to elute and in which the chlorine concentration has been decreased is brought in direct contact with the aqueous solution of the alkali agent 6 being an extraction solvent for zinc to obtain a zinc-containing compound, and a zinc-containing alkali agent aqueous solution 8 containing zinc components is generated as a zinc extract, which is obtained by selectively extracting zinc components from the zinc-containing compound, and solid content not dissolving in the aqueous solution of the alkali agent 6 is regarded as the residues 7.

Typically, a chemical formula in a case of obtaining the zinc-containing alkali agent aqueous solution 8 that is a zinc-containing aqueous solution obtained by selectively extracting zinc components using sodium hydroxide as the alkali agent 6 for zinc oxide in the washed electric arc furnace dust 5 is indicated by the following (Formula 1).

[Formula 1]

ZnO+2NaOH+H₂O→2Na⁺+[Zn(OH)₄]²⁻ (Formula 1)

In the zinc extracting process 102, the residues 7 being zinc-containing compounds may be brought in direct contact with the aqueous solution of the alkali agent 6 to generate a zinc-containing alkali agent aqueous solution 8′ containing zinc components as a zinc extract, which is obtained by selectively extracting the zinc components from the residues 7, and generation of a zinc-containing alkali agent aqueous solution 8″ in the same manner from residues 7′ obtained by the above processing may be repeated. Each time the generation of the zinc-containing alkali agent aqueous solution 8′, 8″ respectively using the residues 7, 7′ is repeated in this way, the chlorine concentration in the zinc-containing alkali agent aqueous solution 8′, 8″ changes and characteristics of zinc 10′, 10″ respectively obtained as an electrolytic product of the electrolyzing process 103 change. For example, when the electric arc furnace dust 1 has not been sufficiently washed in the chlorine-concentration adjusting process 101, the chlorine concentration of the zinc-containing alkali agent aqueous solution 8 obtained in the first zinc extracting process 102 is highest. When the electric arc furnace dust 1 has been sufficiently washed in the chlorine-concentration adjusting process 101, the chlorine concentrations of the zinc-containing alkali agent aqueous solutions 8, 8′, 8″ . . . obtained in the first and subsequent zinc extracting processes 102 are almost equal. There is a tendency that each time a tailing electrolyte obtained in the electrolyzing process 103 is repeatedly used as the aqueous solution of the alkali agent 6 functioning as the extraction solvent for zinc, the increase amount of the chlorine concentration of the zinc-containing alkali agent aqueous solution 8, 8′, 8″ . . . obtained by selectively extracting zinc components using the aqueous solution of the alkali agent 6 becomes larger regardless of whether washing of the electric arc furnace dust 1 in the chlorine-concentration adjusting process 101 is sufficient or insufficient.

Next, in the electrolyzing process 103, the zinc-containing alkali agent aqueous solution 8 containing the zinc components extracted in the zinc extracting process 102 are accommodated as an electrolyte in an electrolytic cell having a pair of electrodes (both not illustrated) and is electrolyzed to deposit zinc 10 on the cathode side, the zinc 10 is subjected to solid-liquid separation to be collected as a solid, and the solid is used as it is as a product. Since the tailing electrolyte that is the electrolyte after the zinc 10 is subjected to the solid-liquid separation and collected contains the alkali agent 6, the tailing electrolyte is returned as it is to the zinc extracting process 102 to be used as a part of the aqueous solution of the alkali agent 6 as the extraction solvent for zinc. In a case in which the alkali agent 6 used in the zinc extracting process 102 is used as the washing agent 3 in the chlorine-concentration adjusting process 101, the tailing electrolyte contains the alkali agent 6 and the tailing electrolyte can therefore be returned as it is to the chlorine-concentration adjusting process 101 to be used as a part of the washing agent 3.

In the zinc production method of the present embodiment described above, an alkali hydroxide aqueous solution is used as the extraction solvent for selectively extracting zinc components in the zinc-containing aqueous-solution generating process 102, and the chlorine-concentration adjusting process 101 of separating chlorine components contained in electric arc furnace dust or secondary dust to decrease the chlorine concentration in the zinc-containing aqueous solution at a stage prior to the electrolyzing process 103 is further included. Therefore, the chlorine concentration in the alkali hydroxide aqueous solution, the zinc-containing aqueous solution, or the tailing electrolyte can be suppressed from being increased and zinc having characteristics of a desired quality can be produced.

Since the chlorine-concentration adjusting process 101 is for washing the electric arc furnace dust or the secondary dust with the alkali hydroxide aqueous solution to separate chlorine components in the zinc production method of the present embodiment, it is possible to reliably separate the chlorine components contained in the electric arc furnace dust or the secondary dust to reliably suppress the chlorine concentration in the alkali hydroxide aqueous solution, the zinc-containing aqueous solution, or the tailing electrolyte from being increased at a stage prior to the zinc-containing aqueous-solution generating process 102 and zinc having characteristics of a desired quality can be produced.

### Second Embodiment

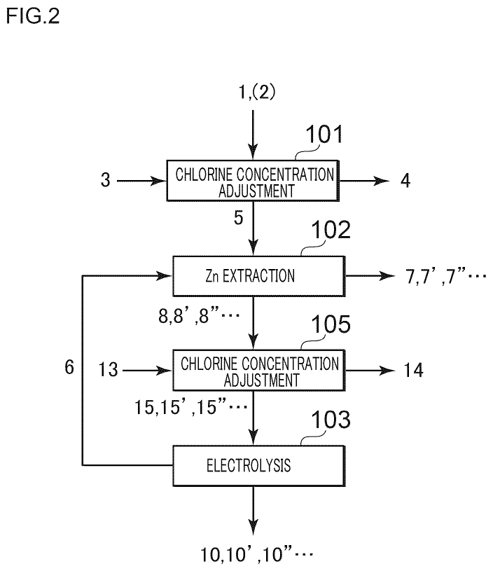

Next, a zinc production method according to a second embodiment of the present invention is explained in detail with reference to FIG. 2.

FIG. 2 is a chart illustrating processes of the zinc production method of the present embodiment.

As illustrated in FIG. 2, a main difference of the zinc production method according to the present embodiment from that according to the first embodiment is that a chlorine-concentration adjusting process 105 is included between the zinc extracting process 102 and the electrolyzing process 103. In the present embodiment, explanations will be made focusing on the difference, and like constituent elements are denoted by like reference signs and explanations thereof are omitted or simplified.

Specifically, in the chlorine-concentration adjusting process 105 following the zinc extracting process 102, an antichlor 13 functioning as a silver ion source, such as silver oxide or silver nitrate is brought in direct contact with the zinc-containing alkali agent aqueous solution 8 that is a zinc extract containing the zinc components extracted in the zinc extracting process 102, to generate a chlorine compound 14 of the antichlor 13 in the zinc-containing alkali agent aqueous solution 8, and a chlorine concentration-adjusted zinc-containing alkali agent aqueous solution 15, from which the chlorine compound 14 has been separated and removed, that is, the chlorine concentration-adjusted zinc-containing alkali agent aqueous solution 15, of which the chlorine concentration has been decreased is obtained. In the chlorine-concentration adjusting process 105, the chlorine concentration-adjusted zinc-containing alkali agent aqueous solution 15, of which the chlorine concentration has been decreased may be obtained by adding a volatile agent such as alcohol to the zinc-containing alkali agent aqueous solution 8 as the zinc extract that contains the zinc components extracted in the zinc extracting process 102, and heating the resultant to volatilize chloride ions contained in the zinc-containing alkali agent aqueous solution 8 as volatile chlorine compounds to outside. It is supposed at that time that heavy metals such as manganese components or aluminum components in the material function as catalysts to cause the chlorine components to react with such the volatile agent.

In a case in which the residues 7 being the zinc-containing compounds are brought in direct contact with the aqueous solution of the alkali agent 6 to generate the zinc-containing alkali agent aqueous solution 8′ containing zinc components as a zinc extract that is obtained by selectively extracting the zinc components from the residues 7, and generation of the zinc-containing alkali agent aqueous solution 8″ in the same manner from the resultant residues 7′ is further repeated in the zinc extracting process 102, chlorine concentration-adjusted zinc-containing alkali agent aqueous solutions 15′ and 15″ are correspondingly obtained in the chlorine-concentration adjusting process 105.

Next, in the electrolyzing process 103, electrolysis is performed using the chlorine concentration-adjusted zinc-containing alkali agent aqueous solution 15, 15′, 15″, of which the chlorine concentration has been decreased in the chlorine-concentration adjusting process 105 as the electrolyte to deposit zinc 10, 10′, 10″ on the cathode side, the zinc 10, 10′, 10″ is subjected to solid-liquid separation to be collected as a solid, and the solid is handled as it is as a product. Since the tailing electrolyte that is the electrolyte after the zinc 10, 10′, 10″ is subjected to the solid-liquid separation and collected contains the alkali agent 6, the tailing electrolyte is returned as it is to the zinc extracting process 102.

In the present embodiment, when the chlorine concentration of the electric arc furnace dust 1 or the secondary dust 2 used as the material is low, it is possible to include only the chlorine-concentration adjusting process 105 without including both the chlorine-concentration adjusting processes 101 and 105.

According to the zinc production method of the present embodiment described above, the chlorine-concentration adjusting processes 101 and 105 of using an alkali hydroxide aqueous solution as the extraction solvent for selectively extracting zinc components in the zinc-containing aqueous-solution generating process 102 and separating chlorine components contained in the electric arc furnace dust or the secondary dust to decrease the chlorine concentration of the zinc-containing aqueous solution at a stage prior to the electrolyzing process 103 are further included in addition to the configuration of the first embodiment. Therefore, increase of the chlorine concentration in the alkali hydroxide aqueous solution, the zinc-containing aqueous solution, or the tailing electrolyte can be suppressed and zinc having characteristics of a desired quality can be produced.

In the zinc production method of the present embodiment, the chlorine-concentration adjusting process 105 is for bringing the antichlor in contact with the zinc-containing aqueous solution to separate chlorine components. Therefore, the chlorine components contained in the electric arc furnace dust or the secondary dust can be supplementarily separated between the zinc-containing aqueous-solution generating process 102 and the electrolyzing process 103 to reliably suppress increase of the chlorine concentration in the alkali hydroxide aqueous solution, the zinc-containing aqueous solution, or the tailing electrolyte, and zinc having characteristics of a desired quality can be produced.

### Third Embodiment

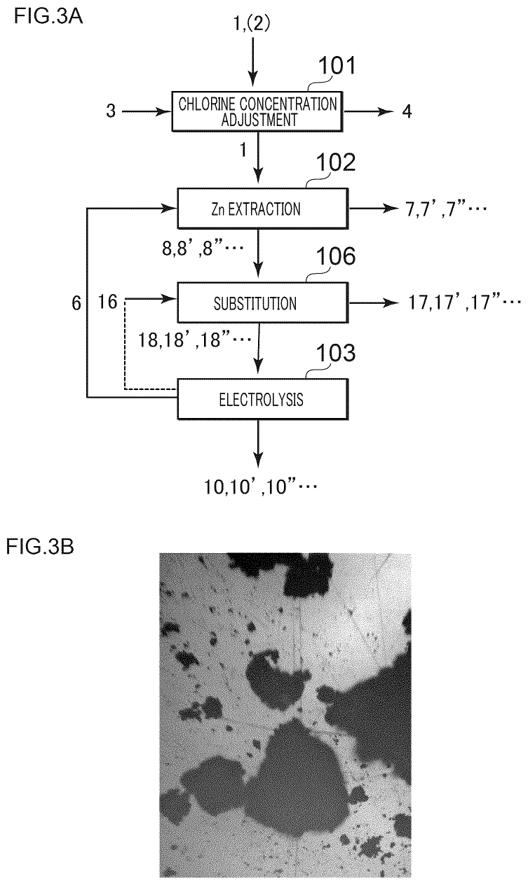

Next, a zinc production method according to a second embodiment of the present invention is explained in detail with reference to FIGS. 3A and 3B.

FIG. 3A is a process chart of the zinc production method according to the present embodiment, and FIG. 3B is a diagram illustrating a micrograph of zinc generated when an electrolytic bath of a high chlorine concentration is used in the zinc production method according to the present embodiment.

As illustrated in FIG. 3A, a main difference of the zinc production method according to the present embodiment from that according to the first embodiment is that a substituting process (a cementation process) 106 is included between the zinc extracting process 102 and the electrolyzing process 103. In the present embodiment, explanations will be made focusing on the difference, and like constituent elements are denoted by like reference signs and explanations thereof are omitted or simplified.

Specifically, in the substituting process 106 following the zinc extracting process 102, the zinc-containing alkali agent aqueous solution 8 that is a zinc extract containing the zinc components extracted in the zinc extracting process 102 is brought in direct contact with metallic zinc 16 such as zinc particles to reduce and deposit metallic impurity components 17 such as copper, lead, and cadmium that are more precious than zinc in the zinc-containing alkali agent aqueous solution 8, thereby obtaining a zinc-containing alkali agent aqueous solution 18 having the decreased concentration of impurity components in the zinc-containing alkali agent aqueous solution 8.

In a case in which the residues 7 being the zinc-containing compounds are brought in direct contact with the aqueous solution of the alkali agent 6 to generate the zinc-containing alkali agent aqueous solution 8′ containing zinc components as a zinc extract that is obtained by selectively extracting the zinc components from the residues 7, and generation of the zinc-containing alkali agent aqueous solution 8″ in the same manner from the resultant residues 7′ is further repeated in the zinc extracting process 102, zinc-containing alkali agent aqueous solutions 18′, 18″ in which the concentration of the impurity components has been decreased, and metallic impurity components 17′, 17″ are correspondingly obtained in the substituting process 106.

Next, in the electrolyzing process 103, electrolysis is performed using the zinc-containing alkali agent aqueous solution 18, 18′, 18″ in which the concentration of the impurity components has been decreased in the substituting process 106 as the electrolyte to deposit zinc 10, 10′, 10″ on the cathode side, the zinc 10, 10′, 10″ is subjected to solid-liquid separation to be collected as a solid, and the solid is handled as it is as a product. Since the tailing electrolyte that is the electrolyte after the zinc 10, 10′, 10″ is subjected to the solid-liquid separation and collected contains the alkali agent 6, the tailing electrolyte is returned as it is to the zinc extracting process 102. In a case in which the electric arc furnace dust 5 and the residues 7, 7′ being zinc-containing compounds are brought in direct contact with the aqueous solution of the alkali agent 6 to repeatedly generate the zinc-containing alkali agent aqueous solution 8, 8′, 8″ containing zinc components as the zinc extract that is obtained by selectively extracting zinc components from the electric arc furnace dust 5 and the residues 7, 7′ in the zinc extracting process 102 and when, for example, the chlorine concentration of the zinc-containing alkali agent aqueous solution 18 is high among the chlorine concentrations of the zinc-containing alkali agent aqueous solutions 18, 18′, 18″ having passed through the substituting process 106, the zinc 10 generated in the electrolyzing process 103 has a high tendency to be in the state of metallic zinc particles as illustrated in FIG. 3B. Therefore, such zinc 10 of an electrolytic product may be returned to the substituting process 106 to be used as the metallic zinc 16 in the particle state.

The chlorine-concentration adjusting process 105 of the zinc production method of the second embodiment may be provided between the zinc extracting process 102 and the substituting process 106 of the zinc production method of the present embodiment.

According to the zinc production method of the present embodiment described above, the substituting process 106 of bringing metallic zinc in contact with the zinc-containing aqueous solution generated in the zinc extracting process 102 to reduce and deposit metallic impurity components that are more precious than zinc in the zinc-containing aqueous solution is further included in addition to the configuration of the first or second embodiment, and electrolysis using the zinc-containing aqueous solution having passed through the substituting process 106 as the electrolyte is performed in the electrolyzing process 103. Therefore, zinc in which mixed impurities have been decreased can be stably mass-produced at a high yield.

Furthermore, in the zinc production method of the present embodiment, a first zinc-containing aqueous solution, and a second zinc-containing aqueous solution that has a lower chlorine concentration than that of the first zinc-containing aqueous solution are generated as the zinc-containing aqueous solution generated in the zinc-containing aqueous-solution generating process 102, and zinc generated by performing electrolysis using the first zinc-containing aqueous solution as the electrolyte in the electrolyzing process 103 is used as metallic zinc in the substituting process 106. Therefore, the substituting process 106 can be efficiently performed effectively using zinc that is an electrolytic product, and zinc in which mixed impurities have been decreased can be stably mass-produced at a high yield.

### Fourth Embodiment

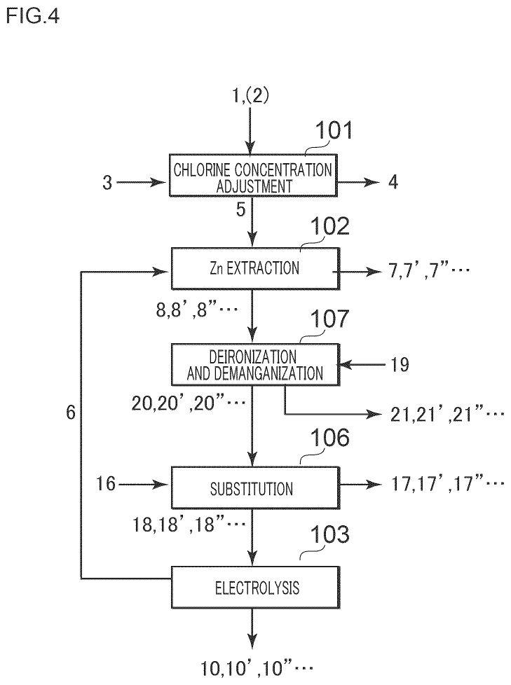

Next, a zinc production method according to a fourth embodiment of the present invention is explained in detail with reference to FIG. 4.

FIG. 4 is a process chart of the zinc production method of the present embodiment.

As illustrated in FIG. 4, a main difference of the zinc production method according to the present embodiment from that according to the third embodiment is that a deironizing and demanganizing process 107 is included between the zinc extracting process 102 and the substituting process 106. In the present embodiment, explanations will be made focusing on the difference, and like constituent elements are denoted by like reference signs and explanations thereof are omitted or simplified.

Provision of the deironizing and demanganizing process 107 in the present embodiment is particularly effective in a case in which iron components or manganese components contained in the electric arc furnace dust or the like are Fe (II), Mn (II), or the like that are soluble in alkali. Even when the iron components or the manganese components are insoluble in alkali, the provision of the deironizing and demanganizing process 107 is effective because, for example, when a zinc-containing aqueous solution in which Fe (III), Mn (IV), or the like that are insoluble in alkali are suspended is treated in the substituting process, Fe (III) and Mn (IV) are reduced to alkali-soluble Fe (II) or the like to be dissolved in the zinc-containing aqueous solution. Furthermore, since the iron components or the manganese components that are soluble in alkali are sometimes generated in the substituting process 106, the substituting process may be provided at a stage prior to the deironizing and demanganizing process, as well as being provided at a stage subsequent to the deironizing and demanganizing process. Aeration and an oxidation method with addition of permanganate are cited as specific methods of the deironizing and demanganizing process 107. When the soluble manganese components are Mn (VII), a method of bringing the manganese components in contact with activated carbon is cited as an example.

Specifically, in the deironizing and demanganizing process 107 following the zinc extracting process 102, to remove iron components and soluble manganese contained in the zinc-containing alkali agent aqueous solution 8 that is the zinc extract containing zinc components extracted in the zinc extracting process 102, iron or soluble manganese components contained in this zinc-containing alkali agent aqueous solution 8 are oxidized and the iron components and the manganese components in the zinc-containing alkali agent aqueous solution 8 are separated and removed as sludge 21 of insoluble sediments to obtain a zinc-containing alkali agent aqueous solution 20 in which the concentration of impurity components has been decreased. Specifically, an oxidant 19 such as air, oxygen, permanganate, hydrogen peroxide, persulfate, chlorate, or chlorine dioxide is added to the zinc-containing alkali agent aqueous solution 8 to oxidize ferrous components in the zinc-containing alkali agent aqueous solution 8 into ferric components and to oxide soluble manganese to be transformed into insoluble manganese dioxide, and the resultants are separated and removed as the sludge 21. The iron components in the zinc-containing alkali agent aqueous solution 8 can also be transformed into magnetic iron oxide such as maghemite containing both ferrous components and ferric components by controlling the temperature, the alkali concentration, and the oxidation-reduction potential (ORP) value.

When permanganate is used as the oxidant 19, the end of demanganization can be determined by supplying permanganate until excess permanganic acid remains in the zinc-containing alkali agent aqueous solution 8. The remaining permanganic acid is brought in direct contact with activated carbon to be transformed into insoluble manganese dioxide and is removed.

In a case in which the residues 7 being zinc-containing compounds are brought in direct contact with the aqueous solution of the alkali agent 6 to generate the zinc-containing alkali agent aqueous solution 8′ containing zinc components as a zinc extract that is obtained by selectively extracting the zinc components from the residues 7, and generation of the zinc-containing alkali agent aqueous solution 8″ in the same manner from the resultant residues 7′ is further repeated in the zinc extracting process 102, zinc-containing alkali agent aqueous solutions 20′ and 20″ in which the concentrations of impurity components have been decreased and sludge 21′ and 21″ are correspondingly obtained in the deironizing and demanganizing process 107.

Next, in the substituting process 106, the zinc-containing alkali agent aqueous solution 20, 20′, 20″ in which the concentration of impurity components has been decreased in the deironizing and demanganizing process 107 is brought in contact with the metallic zinc 16 such as zinc particles to reduce and deposit the metallic impurity components 17 such as copper, lead, and cadmium that are more precious than zinc in the zinc-containing alkali agent aqueous solution 20, 20′, 20″, thereby obtaining the zinc-containing alkali agent aqueous solution 18, 18′, 18″ having the further decreased concentration of impurity components in the zinc-containing alkali agent aqueous solution 20, 20′, 20″.

As for the order of performing the deironizing and demanganizing process 107 and the substituting process 106, the process following the substituting process 106 may be the deironizing and demanganizing process 107. For example, when a material having passed through an iron reducing process, such as secondary dust is used, there is a case in which iron components contained in the material contain many divalent components (Fe(II): ferrous components) and it is more rational to perform the substituting process 106 prior to the deironizing and demanganizing process 107 when treating this material. Such a circumstance also applies to an embodiment in which the deironizing and demanganizing process 107 is divided into a deironizing process and a demanganizing process and these processes are individually performed.

Next, in the electrolyzing process 103, electrolysis is performed using the zinc-containing alkali agent aqueous solution 18, 18′, 18″ in which the concentration of impurity components has been decreased in the substituting process 106 as the electrolyte to deposit zinc 10, 10′, 10″ on the cathode side, the zinc 10, 10′, 10″ is subjected to solid-liquid separation to be collected as a solid, and the solid is handled as it is as a product. Since the tailing electrolyte that is the electrolyte after the zinc 10, 10′, 10″ is subjected to the solid-liquid separation and collected contains the alkali agent 6, the tailing electrolyte is returned as it is to the zinc extracting process 102.

Also in the zinc production method of the present embodiment, similarly to that of the third embodiment, when, for example, the chlorine concentration in the zinc-containing alkali agent aqueous solution 18 is high among the chlorine concentrations of the zinc-containing alkali agent aqueous solutions 18, 18′, 18″ having passed through the substituting process 106, the zinc 10 being the resultant electrolytic product may be returned to the substituting process 106 to be used as the metallic zinc 16 in the particle state. The chlorine-concentration adjusting process 105 of the zinc production method of the second embodiment may be provided between the zinc extracting process 102 and the deironizing and demanganizing process 107 in the zinc production method of the present embodiment.

According to the zinc production method of the present embodiment described above, the deironizing and demanganizing process 107 of bringing the zinc-containing aqueous solution generated in the zinc-containing aqueous-solution generating process 102 in contact with an oxidant to separate iron components and manganese components in the zinc-containing aqueous solution, and the substituting process 106 of bringing the zinc-containing aqueous solution having passed through the deironizing and demanganizing process 107 in contact with metallic zinc to reduce and deposit metallic impurity components that are more precious than zinc in the zinc-containing aqueous solution are further included in addition to the configuration of the first or second embodiment, and electrolysis using the zinc-containing aqueous solution having passed through the substituting process 106 as the electrolyte is performed in the electrolyzing process 103. Therefore, zinc in which mixed impurities have been decreased can be stably mass-produced at a high yield.

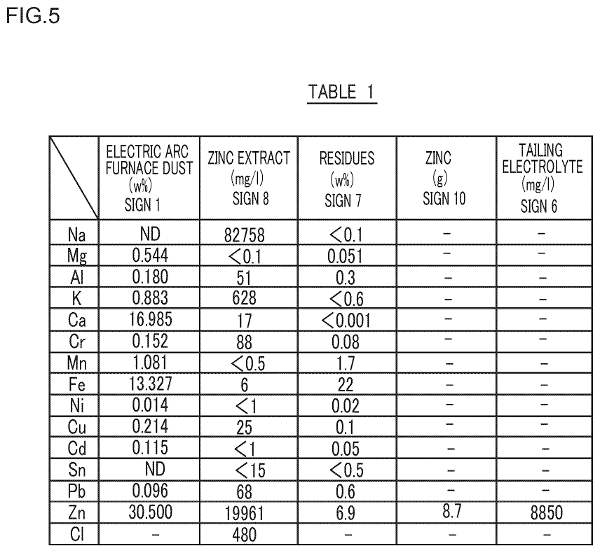

Finally, experimental examples corresponding to the first to fourth embodiments are representatively explained in detail for the embodiments explained above with reference also to FIGS. 5 to 8.

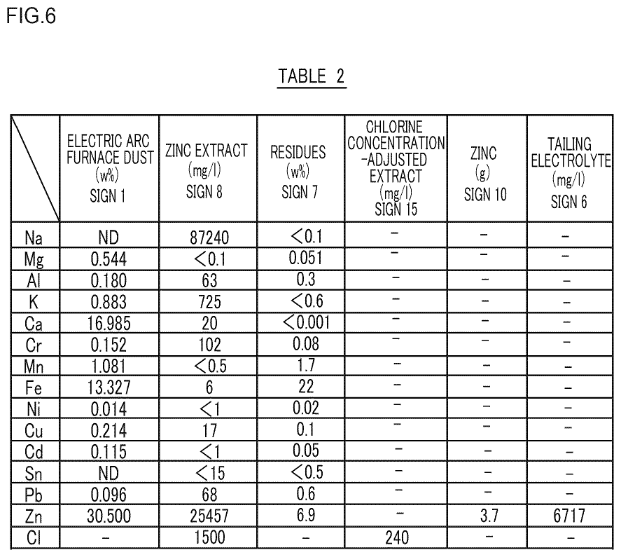

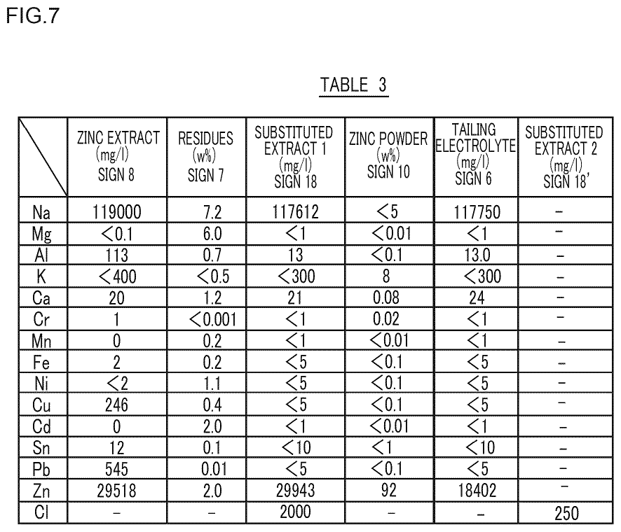

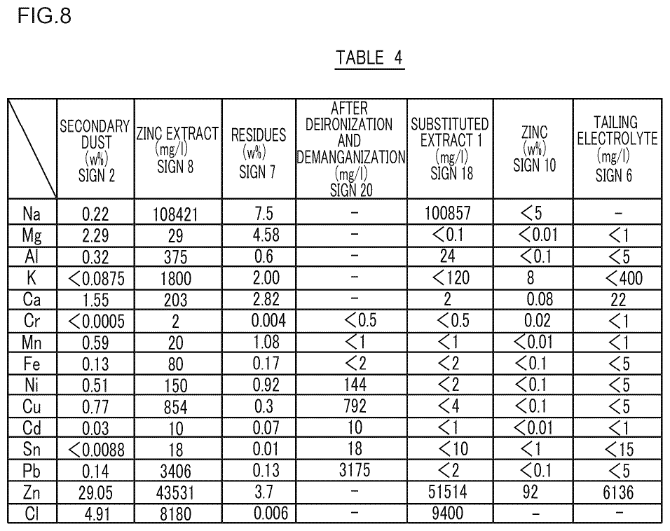

FIG. 5 is a table 1 indicating correspondingly a result of a first experimental example of the first embodiment of the present invention, FIG. 6 is a table 2 indicating a result of a second experimental example of the second embodiment of the present invention, FIG. 7 is a table 3 indicating correspondingly a result of a first experimental example of the third embodiment of the present invention, and FIG. 8 is a table 4 indicating a second experimental example of the fourth embodiment of the present invention. ND in the tables indicate “not detected”. Blank columns in the tables indicate “below detection limit” or “not detected” with regard to electric arc furnace dust, secondary dust, and residues, and indicate “out of targets to be analyzed” with regard to items other than the electric arc furnace dust, the secondary dust, and residues.

### First Experimental Example

The present experimental example is an experimental example corresponding to the first embodiment of the present invention, and a result thereof is indicated in the table 1 of FIG. 5.

First, in the chlorine-concentration adjusting process 101, the secondary dust 2 weighing 60.5 g was sorted from 870 g of secondary dust that was previously obtained by mixing calcium carbonate 11 weighing 441 g with the electric arc furnace dust 1 weighing 762.8 g and calcining the resultant in the calcining process 104, the sorted secondary dust 2 was washed with an NaOH aqueous solution at a concentration of 0.8% as the washing agent 3 to cause the chlorine components to elute, whereby the secondary dust 5 having a decreased chlorine concentration was obtained. The NaOH aqueous solution as the washing agent 3 was repeatedly used in the chlorine-concentration adjusting process 101.

Next, in the zinc extracting process 102, the secondary dust 5 that was washed to decrease the chlorine concentration in the chlorine-concentration adjusting process 101 was brought in contact with an NaOH aqueous solution weighing 1000 g and having a concentration of 16.5% as an aqueous solution of the alkali agent 6, and the zinc extract (the zinc-containing alkali agent aqueous solution) 8 having a chlorine concentration of 480 mg/l and a volume of 770 ml was obtained as the remaining liquid by separating solid content that does not dissolve in the aqueous solution of the alkali agent 6 by filtration. The residues 7 weighing 46.2 g were obtained by filtering the solid content that does not dissolve in the aqueous solution of the alkali agent 6, washing the solid content with pure water, and then drying the resultant. As extraction conditions of the zinc extracting process 102, the temperature was 95° C., the pressure was the normal pressure, and the time of contact between the aqueous solution of the alkali agent 6 and the secondary dust 2 was set to eight hours. A filtrate from which the residues 7 had been separated by filtering (a filtrate obtained by extracting extractable components from insoluble solid components) was subsequently repeatedly used as the alkali agent 6 for dissolving the secondary dust 2.

Next, in the electrolyzing process 103, electrolysis was performed using the zinc-containing alkali agent aqueous solution 8 containing the zinc components extracted in the zinc extracting process 102 as the electrolyte, whereby smooth metallic zinc (foil) 10 weighing 8.7 g was obtained. The tailing electrolyte being the electrolyte after the zinc 10 had been subjected to the solid-liquid separation and collected was returned as it was to the zinc extracting process 102, and was repeatedly used as a part of the aqueous solution of the alkali agent 6 being the extraction solvent for zinc. As electrolysis conditions of the electrolyzing process 103, flat plates made of stainless steel (SUS304) and having a plate thickness of 1 mm were used as electrodes (a cathode and an anode), the distance between the cathode and the anode was set to 20 mm, and the electrolysis was performed for a period of 8.5 hours while constant current control at 1 A was executed so as to obtain 62.5 mA/cm² of the current density of a geometric area criterion. The deposition current efficiency of zinc at that time was 84%.

### Second Experimental Example

The present experimental example is an experimental example corresponding to the second embodiment of the present invention, and a result thereof is indicated in the table 2 of FIG. 6.

By returning the tailing electrolyte obtained in the electrolyzing process 103 of the first experimental example to the zinc extracting process 102 and repeatedly using the tailing electrolyte as a part of the aqueous solution of the alkali agent 6 being the extraction solvent of zinc, the chlorine concentration of the zinc extract (the zinc-containing alkali agent aqueous solution) 8 became 1500 mg/l in the zinc extracting process 102 because of concentration of the chlorine components.

Next, in the chlorine-concentration adjusting process 105, AgCl deposited in the zinc-containing alkali agent aqueous solution 8 that had been extracted in the zinc extracting process 102 by adding silver nitrate as the antichlor 13 to the zinc-containing alkali agent aqueous solution 8 was removed as the chlorine compound 14 by filtration, thereby to obtain a zinc-containing alkali agent aqueous solution in which the chlorine concentration had been decreased to 240 mg/l, and zinc particles were brought in contact with the obtained zinc-containing alkali agent aqueous solution to deposit Ag remaining therein to be separated by filtration, so that the zinc-containing alkali agent aqueous solution 15 in which the chlorine concentration had been decreased to 240 mg/l and from which Ag had been removed was obtained.

Next, in the electrolyzing process 103, smooth metallic zinc (foil) 10 weighing 3.7 g was obtained by performing electrolysis using the zinc-containing alkali agent aqueous solution 15, of which the chlorine concentration had been decreased in the chlorine-concentration adjusting process 105, as the electrolyte. The tailing electrolyte being the electrolyte after the zinc 10 had been subjected to the solid-liquid separation and collected was returned as it was to the zinc extracting process 102, and was repeatedly used as a part of the aqueous solution of the alkali agent 6 being the extraction solvent for zinc. As electrolysis conditions of the electrolyzing process 103, flat plates made of stainless steel (SUS304) and having a plate thickness of 1 mm were used as electrodes (the cathode and the anode), the distance between the cathode and the anode was set to 20 mm, the size in the solution was set to be 20 mm in the width and 30 mm in the height, and the electrolysis was performed for a period of 10 hours while constant current control at 375 mA was executed so as to obtain 62.5 mA/cm² of the current density of a geometric area criterion. The deposition current efficiency of zinc at that time was 81%, and the average value of voltages between the cathode and the anode was 2.4 V.

### Third Experimental Example

The present experimental example is an experimental example corresponding to the third embodiment of the present invention and a result thereof is indicated in the table 3 of FIG. 7.

In the zinc extracting process 102 following the chlorine-concentration adjusting process 101, the secondary dust (a crude zinc oxide sample) 5 derived from electric arc furnace dust, weighing 100 g, and having been washed to decrease the chlorine concentration in the chlorine-concentration adjusting process 101 was brought in contact with an NaOH aqueous solution at a concentration of 16.5% as an aqueous solution of the alkali agent 6, the total amount of solid content not dissolving in the aqueous solution of the alkali agent 6 was separated by filtration to obtain the residues 7, and the zinc extract (the zinc-containing alkali agent aqueous solution) 8 was obtained as the remaining liquid. Next, the residues 7 were brought in contact with an NaOH aqueous solution at a concentration of 16.5% as a new aqueous solution of the alkali agent 6, the total amount of solid content not dissolving in the aqueous solution of the alkali agent 6 was separated as the residues 7′ by filtration, and the zinc extract (the zinc-containing alkali agent aqueous solution) 8′ was obtained as the remaining liquid. Conditions of the zinc extracting process 102 of the present experimental example were the same as those of the first experimental example.

Next, in the substituting process 106, the zinc-containing alkali agent aqueous solution 8 that is the zinc extract containing the zinc components extracted in the zinc extracting process 102 was brought in contact with zinc particles being the metallic zinc 16 to reduce and deposit the metallic impurity components 17 such as copper, lead, and cadmium that are more precious than zinc in the zinc-containing alkali agent aqueous solution 8, and the zinc-containing alkali agent aqueous solution 18 having a decreased concentration of impurity components was obtained.

Next, in the electrolyzing process 103, electrolysis was performed using the zinc-containing alkali agent aqueous solution 18 in which the concentration of the impurity components had been decreased in the substituting process 106 as an electrolyte at a chlorine concentration of 2000 mg/l, and the metallic zinc (powder having a particle diameter of about 500 μm) 10 weighing 2.6 g and having a purity of 92% was obtained. A tailing electrolyte that is the electrolyte after the zinc 10 had been subjected to the solid-liquid separation and collected was returned as it was to the zinc extracting process 102, and was repeatedly used as a part of the aqueous solution of the alkali agent 6 being the extraction solvent for zinc. As electrolysis conditions of the electrolyzing process 103, flat plates made of stainless steel (SUS304) and having a plate thickness of 1 mm were used as electrodes (the cathode and the anode), the distance between the cathode and the anode was set to 20 mm, the size in the solution was set to be 20 mm in the width and 20 mm in the height, and the electrolysis was performed for a period of eight hours while constant current control at 250 mA was executed so as to obtain 62.5 mA/cm² of the current density of a geometric area criterion. The deposition current efficiency of zinc at that time was 97.7%, and the average value of voltages between the cathode and the anode was 2.35 V.

Next, in the second substituting process 106, the metallic zinc (the powder having a particle diameter of about 500 μm) 10 obtained in the manner described above was brought in contact with the zinc-containing alkali agent aqueous solution 8′ obtained in the zinc extracting process 102 to reduce and deposit the metallic impurity components 17′ such as copper, lead, and cadmium that are more precious than zinc in the zinc-containing alkali agent aqueous solution 8′, and the zinc-containing alkali agent aqueous solution 18′ having a decreased concentration of impurity components was obtained.

Next, in the second electrolyzing process 103, the electrolysis was performed using the zinc-containing alkali agent aqueous solution 18′ in which the concentration of the impurity components had been decreased in the second substituting process 106 as an electrolyte at a chlorine concentration of 250 mg/l, and the metallic zinc (foil) 10′ was obtained. A tailing electrolyte that is the electrolyte after the zinc 10′ had been subjected to the solid-liquid separation and collected was returned as it was to the zinc extracting process 102, and was repeatedly used as a part of the aqueous solution of the alkali agent 6 being the extraction solvent for zinc. The electrolysis conditions of the second electrolyzing process 103 were set to be same as those in the second electrolyzing process 103.

### Fourth Experimental Example

The present experimental example is an experimental example corresponding to the fourth embodiment of the present invention and a result thereof is indicated in the table 4 of FIG. 8.

In the zinc extracting process 102 following the chlorine-concentration adjusting process 101, the secondary dust (a crude zinc oxide sample) 5 weighing 300 g, derived from electric arc furnace dust, and having been washed to decrease the chlorine concentration in the chlorine-concentration adjusting process 101 was brought in contact with an NaOH aqueous solution having a concentration of 16.5% as an aqueous solution of the alkali agent 6 and was agitated, then the total amount thereof was filtered to separate the total amount of solid content not dissolving in the aqueous solution of the alkali agent 6 as the residues 7 by filtration, and 1800 ml of the zinc extract (the zinc-containing alkali agent aqueous solution) 8 was obtained as the remaining liquid. Next, the residues 7 were brought in contact with an NaOH aqueous solution at a concentration of 16.5% as a new aqueous solution of the alkali agent 6, the total amount of solid content not dissolving in the aqueous solution of the alkali agent 6 was separated by filtration to obtain the residues 7′, and the zinc extract (the zinc-containing alkali agent aqueous solution) 8′ was obtained as the remaining liquid. Conditions of the zinc extracting process 102 of the present experimental example were set to be same as those in the first experimental example.

Next, in the deironizing and demanganizing process 107 following the zinc extracting process 102, activated carbon weighing 10 g was added under heat to a red red liquid obtained by adding KMnO₄ crystals weighing 0.1 g as the oxidant 11 to the zinc-containing alkali agent aqueous solution 8, 8′, the liquid was sucked and filtered with a membrane filter having a filtration accuracy of 0.1 μm after it was confirmed that the liquid had become transparent, whereby a filtrate (a deironized and demanganized zinc-containing alkali agent aqueous solution 20, 20′) was obtained. Deironized and demanganized sludge 21, 21′ weighing 263 mg was obtained as solid content on filter paper.

Next, the substituting process 106 following the deironizing and demanganizing process 107 was performed using the zinc-containing alkali agent aqueous solution 20, 20′ in the same manner as that in the third experimental example to obtain the zinc-containing alkali agent aqueous solution 18, 18′, and the electrolyzing process 103 was performed using the zinc-containing alkali agent aqueous solution 18, 18′ as an electrolytic bath to obtain the metallic zinc 10, 10′ that are same as those in the third experimental example, respectively. A tailing electrolyte that is the electrolyte after collection of the zinc 10 was returned as it was to the zinc extracting process 102 and was repeatedly used as a part of the aqueous solution of the alkali agent 6 being the extraction solvent for zinc. The electrolysis conditions of the electrolyzing process 103 were set to be same as those in the electrolyzing process 103 of the third experimental example.

### Fifth Embodiment

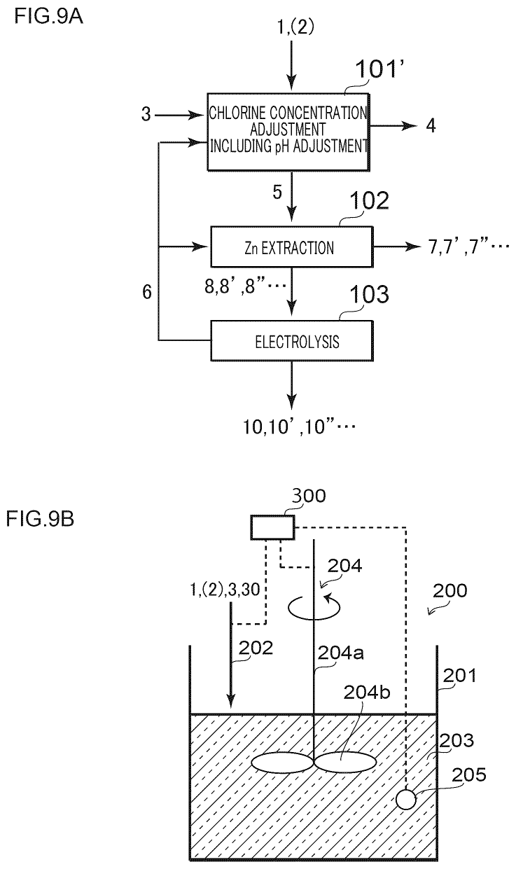

Finally, a zinc production method according to a fifth embodiment of the present invention is explained in detail with reference to FIGS. 9A and 9B.

FIG. 9A is a chart illustrating processes of the zinc production method of the present embodiment, and FIG. 9B is a schematic diagram illustrating a configuration of a washer used in the chlorine-concentration adjusting process including adjustment of pH (hydrogen ion exponent) in the present embodiment.

As illustrated in FIG. 9A, a main difference of the zinc production method according to the present embodiment from that according to the first embodiment is that adjustment of the pH value is performed in addition to the adjustment of the chlorine concentration in a chlorine-concentration adjusting process 101′. In the present embodiment, explanations will be made focusing on the difference, and like constituent elements are denoted by like reference signs and explanations thereof are omitted or simplified.

First, according to studies made by the present inventors, premising a configuration in which a strong alkali agent, typically an alkali agent being hydroxide is adopted as the washing agent 3 to be used in the chlorine-concentration adjusting process 101, the electric arc furnace dust 1 or the secondary dust 2 (hereinafter, “electric arc furnace dust 1”) is brought in contact with an alkali aqueous solution that is a washing liquid being an aqueous solution of the alkali agent to cause chlorine component adsorbing on the electric arc furnace dust 1 to elute and separate therefrom as in the first embodiment, specifically, the electric arc furnace dust 1 previously broken into a predetermined size or smaller is immersed into the alkali aqueous solution, the electric arc furnace dust 1 immersed in this way is agitated in the alkali aqueous solution for a predetermined time to be slurried, and the chlorine components having adhered to the slurry electric arc furnace dust 1 are caused to elute therefrom.

According to the studies made by the present inventors, it was found that the pH value of the slurry electric arc furnace dust 1 needs to be a value smaller than the pH value of the alkali aqueous solution being the aqueous solution of the alkali agent 6 used in the zinc extracting process 102 and to be kept at not less than 8.5 and not more than 10.5 to practically cause the chlorine components to elute from the electric arc furnace dust 1 slurried in the alkali aqueous solution. This is because it was found that, if the pH value is less than 8.5 as the lower limit value, a practicable amount of the chlorine components eluted from the electric arc furnace dust 1 cannot be provided and unnecessary elution of zinc components and lead components from the electric arc furnace dust 1 occurs. Meanwhile, the reason for the upper limit is that it was found, if the pH value exceeds 11, the zinc components are extracted from the electric arc furnace dust 1 and the amount of zinc components in the washed electric arc furnace dust 5 to be passed to the zinc extracting process 102 at the next stage decreases, which damages signification of provision of the zinc extracting process 102. According to the studies made by the present inventors, the pH value of the alkali aqueous solution being the aqueous solution of the alkali agent 6 used in the zinc extracting process 102 needs to be at least equal to or more than 13 to increase the amount of zinc components extracted from the washed electric arc furnace dust 5 and to obtain a practicable amount of zinc components, which also implies a premise that the pH value of the slurry electric arc furnace dust 1 in the chlorine-concentration adjusting process 101 is set to be smaller than the pH value of the alkali aqueous solution used in the zinc extracting process 102. In other words, based on the pH value of the alkali aqueous solution being the aqueous solution of the alkali agent 6 used in the zinc extracting process 102, it suffices to set the pH value of the electric arc furnace dust 1 slurried in the chlorine-concentration adjusting process 101 to a value smaller than the pH value of the alkali aqueous solution being the aqueous solution of the alkali agent 6 used in the zinc extracting process 102 by a value within a range not less than 3 and not more than 5. This contributes, for example, when an alkali agent that provides the maximum pH value (already known) among practically available agents is retained as the alkali agent 6 in the zinc extracting process 102 so as to enable zinc components to be maximally extracted, and the alkali agent 6 having the known pH value is diluted and used as the washing agent 3 in the chlorine-concentration adjusting process 101, for easy and quick calculation of the initial amount of water to be added to the alkali agent 6 to realize a pH value that is smaller than the known pH value by a value within the range not less than 3 and not more than 5. A typical example that is practically suitable as the washing agent 3 and the alkali agent 6 is sodium hydroxide.

That is, specifically in the present embodiment, a strong alkali agent, more specifically, an alkali agent being hydroxide is used as the washing agent 3, an alkali aqueous solution that is a washing liquid being an aqueous solution of the alkali agent is prepared, the electric arc furnace dust 1 previously broken into a predetermined size or smaller is immersed into the alkali aqueous solution, the electric arc furnace dust 1 in the state immersed in this way is agitated in the alkali aqueous solution for a predetermined time to be slurried, and chlorine components are caused to elute out of the slurry electric arc furnace dust 1 to be separated from the electric arc furnace dust 1, whereby the washed electric arc furnace dust 5 is obtained in the chlorine-concentration adjusting process 101′ as illustrated in FIG. 9A.

The alkali aqueous solution being the washing liquid obtained by uniformly dissolving the washing agent 3 into water 30, and the electric arc furnace dust 1 immersed therein are supplied from a supply system 202 that is capable of correspondingly supplying the electric arc furnace dust 1, the washing agent 3, and the water 30 into a washing tank 201 of the washer 200, and are accumulated as illustrated in FIG. 9B. The initial value of the pH value of the alkali aqueous solution being the washing liquid is set to a value that is smaller than the pH value of the alkali aqueous solution being an aqueous solution of the alkali agent 6 used in the zinc extracting process 102 and that falls within the range not less than 8.5 and not more than 10.5 (a value smaller by a value within the range not less than 3 and not more than 5 relative to the pH value of the alkali aqueous solution being the aqueous solution of the alkali agent 6 used in the zinc extracting process 102) to enable the initial value of the pH value of the slurry electric arc furnace dust 1 to be roughly provided. The alkali aqueous solution and the electric arc furnace dust 1 immersed therein have slurry characteristics by being continuously agitated by an agitating member 204b that is capable of rotating on a rotation shaft 204a in an agitator 204, and become slurry dust 203 in the washing tank 201.

A pH meter 205 that measures the pH value in the washing tank 201 is installed therein and the pH meter 205 measures the pH value in the washing tank 201, more specifically, the pH value of the slurry dust 203 in the washing tank 201. A detection signal that indicates a voltage showing the pH value measured by the pH meter 205 is transmitted to a controller 300 including an arithmetic processor, a memory, and the like (all not illustrated). The controller 300 having received the detection signal from the pH meter 205 calculates a deviation between the measured pH value indicated by the detection signal and a target pH value (for example, a value 9.5 being the median in the range not less than 8.5 and not more than 10.5, which is smaller than the pH value of the alkali aqueous solution being the aqueous solution of the alkali agent 6 used in the zinc extracting process 102), and adjusts the supply amount of the washing agent 3 to the washing tank 201 and the supply amount of the water 30 to the washing tank 201 according to the deviation to enable the actual pH value to match the target pH value. Specifically, the controller 300 reads a control program and control data stored in advance in the memory, and executes control to increase the supply amount of the water 30 according to a difference value (for example, a positive value) between the measured pH value and the target pH value while referring to the control data when the measured pH value is larger than the target pH value, and increases the supply amount of the washing agent 3 according to a difference value (for example, a negative value) between the measured pH value and the target pH value when the measured pH value is smaller than the target pH value, thereby executing feedback control to enable the actual pH value to approach and match the target pH value. When the measured pH value is equal to the target pH value, the controller 300 keeps the supply amount of the washing agent 3 and the supply amount of the water 30 without any change. The control data for adjusting the supply amount of the washing agent 3 and the supply amount of the water according to a difference value (a deviation) between the measured pH value and the target pH value is map data where a relation between deviations between the measured pH value and the target pH value, and the supply amount of the washing agent 3 and the supply amount of the water 30 is previously defined to enable an actual pH value to match the target pH value. Adjustment of the supply amount of the washing agent 3 and the supply amount of the water 30 is performed by adjusting the opening degree of a valve (not illustrated) and the driving force of a supply pump (not illustrated) provided in the supply system 202. From the viewpoint of providing stability of the feedback control, the controller 300 may keep the supply amount of the washing agent 3 and the supply amount of the water 30 without any change when the absolute value of a difference value between the measured pH value and the target pH value is equal to or lower than a predetermined small value.

When the agitation by the agitator 204, typically the rotation of the rotation shaft 204a at a constant number of rotations has been continued for a certain time previously set as a time required for elution of chlorine components, the adjustment of the chlorine concentration by elution of the chlorine components while adjusting the pH value of the slurry dust 203 in the chlorine-concentration adjusting process 101′ ends, and the slurry dust 203 is subjected to solid-liquid separation, whereby the used washing agent 4 that contains the eluted chlorine components and in which the chlorine concentration has increased, and the washed electric arc furnace dust 5 in which the chlorine components have been decreased are obtained.

The zinc extracting process 102 and the electrolyzing process 103 at the following and subsequent stages are same as those in the first embodiment. However, when the tailing electrolyte that contains the alkali agent 6 containing zinc components and that has still a high pH value in the electrolyzing process 103 is returned to the chlorine-concentration adjusting process 101′ to be reused as a part of the washing agent 3, the pH value of the washing agent 3 with the tailing electrolyte is adjusted to fall within the range not less than 8.5 and not more than 10.5, which prevents further extraction of zinc components from the electric arc furnace dust 1. Therefore, the tailing electrolyte in the electrolyzing process 103 can be of course returned to the zinc extracting process 102 to be used as a part of the aqueous solution of the alkali agent 6 being the extraction solvent for zinc components, and the tailing electrolyte can be also returned to the chlorine-concentration adjusting process 101′ to be used as a practical washing liquid for chlorine components. As an experimental example of the present embodiment, an experiment was performed in the same conditions as those in the first experimental example corresponding to the first embodiment and the same result as that of the first experimental example was stably obtained.

The chlorine-concentration adjusting process 101′ in the present embodiment may be provided instead of the chlorine-concentration adjusting processes 101 in the second to fourth embodiments. Also in the chlorine-concentration adjusting process 101′ in the present embodiment, fluorine may be targeted in addition to chlorine, or instead of chlorine as a target to be separated from the electric arc furnace dust 1 by washing the electric arc furnace dust 1 with the washing agent 3.

In the zinc production method of the present embodiment described above, the chlorine-concentration adjusting process 101′ is for adjusting the pH value of slurry dust, which is obtained by agitating electric arc furnace dust or secondary dust in a state immersed into an alkali hydroxide aqueous solution, to fall within the range not less than 8.5 and not more than 10.5 smaller than the pH value of the alkali hydroxide aqueous solution used in the zinc-containing aqueous-solution generating process 102 at the time of washing the electric arc furnace dust or the secondary dust. Therefore, chlorine components are enabled to elute from the electric arc furnace dust or the secondary dust without extraction of zinc components therefrom and zinc having characteristics of a desired quality can be produced.

In the zinc production method of the present embodiment, the tailing electrolyte in the electrolyzing process 103 is returned to the chlorine-concentration adjusting process 101′, the alkali hydroxide aqueous solution in the chlorine-concentration adjusting process 101′ contains the tailing electrolyte, and the chlorine-concentration adjusting process 101′ is for adjusting the pH value of the slurry dust obtained by agitation in the state immersed into the alkali hydroxide aqueous solution containing the tailing electrolyte. Therefore, even when the tailing electrolyte is used as a part of the washing liquid, chlorine components are enabled to elute from the electric arc furnace dust or the secondary dust without further extraction of zinc components, and zinc having characteristics of a desired quality can be produced.

In the zinc production method of the present embodiment, the chlorine-concentration adjusting process 101′ is for controlling the amount of the alkali agent and the amount of water to obtain the alkali hydroxide aqueous solution in the chlorine-concentration adjusting process 101′ according to a deviation between a target value and a measured value of the pH value of the slurry dust, where the target value is a predetermined value in the range not less than 8.5 and not more than 10.5 smaller than the pH value of the alkali hydroxide aqueous solution used in the zinc-containing aqueous-solution generating process 102. Therefore, the pH value of the slurry dust can be reliably maintained at an appropriate value, and zinc having characteristics of a desired quality can be produced.

In the present invention, the shapes, arrangements, numbers, and the like of constituent elements are not limited to those described in the above embodiments, and it is needless to mention that changes can be appropriately made without departing from the scope of the invention, such as appropriately replacing these constituent elements with other members having equivalent operational effects.

### INDUSTRIAL APPLICABILITY

As described above, the present invention can provide a zinc production method that can decrease the chlorine concentration in processes when zinc components in electric arc furnace dust or secondary dust are selectively extracted using an alkali hydroxide aqueous solution as an extraction solvent to generate a zinc-containing aqueous solution, and the zinc-containing aqueous solution is electrolyzed to produce zinc as an electrolytic product. Therefore, the present invention is expected to be broadly applicable to a zinc production method using, as a material, electric arc furnace dust generated at the time of melting and smelting of scraps in electric furnace steelmaking being one of iron and steel making processes, or secondary dust generated in a reduction furnace when a part of the electric arc furnace dust is recycled as a material for iron and steelmaking because of its general and versatile property.

### REFERENCE SIGNS LIST

1 electric arc furnace dust
2 secondary dust
3 washing agent
4 used washing agent
5 washed electric arc furnace dust
6 alkali agent
7 residues
8 zinc-containing alkali agent aqueous solution
10 zinc
11 calcium carbonate
12 carbon dioxide
13 antichlor
14 chlorine compound
15 chlorine concentration-adjusted zinc-containing alkali agent aqueous solution
16 metallic zinc
17 metallic impurity component
18 impurity components-decreased zinc-containing alkali agent aqueous solution
19 oxidant
20 impurity components-decreased zinc-containing alkali agent aqueous solution
21 sludge
30 water
101 chlorine-concentration adjusting process
101′ chlorine-concentration adjusting process including pH adjustment
102 zinc extracting process (zinc-containing aqueous-solution generating process)
103 electrolyzing process
104 calcining process
105 chlorine-concentration adjusting process
106 substituting process
107 deironizing and demanganizing process
200 washer
201 washing tank
202 supply system
203 slurry electric arc furnace dust
204 agitator
204a rotation shaft
204b agitating member
205 pH meter

1. A zinc production method, comprising:
a zinc-containing aqueous-solution generating step of using, as a material, electric arc furnace dust or secondary dust generated when the electric arc furnace dust is reduced in a reduction furnace, and selectively extracting zinc components in the material to generate a zinc-containing aqueous solution containing the zinc components; and
an electrolyzing step of performing electrolysis using the zinc-containing aqueous solution as an electrolyte to generate zinc and returning a tailing electrolyte that is the electrolyte having been subjected to the electrolysis to the zinc-containing aqueous-solution generating step, wherein
an alkali hydroxide aqueous solution is used as an extraction solvent for selectively extracting the zinc components in the zinc-containing aqueous-solution generating step, and
a chlorine-concentration adjusting step of separating chlorine components contained in the electric arc furnace dust or the secondary dust to decrease a chlorine concentration of the zinc-containing aqueous solution at a stage prior to the electrolyzing step is further included.
in the chlorine-concentration adjusting step, the electric arc furnace dust or the secondary dust is washed with an alkali hydroxide aqueous solution as a washing liquid to separate the chlorine components, and
in the chlorine-concentration adjusting step, at a time of washing the electric arc furnace dust or the secondary dust with the alkali hydroxide aqueous solution as the washing liquid, a pH value of slurry dust obtained by agitating the electric arc furnace dust or the secondary dust in a state immersed in the alkali hydroxide aqueous solution as the washing liquid is adjusted to fall within a range not less than 8.5 and not more than 10.5 smaller than a pH value of the alkali hydroxide aqueous solution used as the extraction solvent in the zinc-containing aqueous-solution generating step, and the alkali hydroxide aqueous solution as the washing liquid having been used for washing and containing the separated chlorine components is discharged outside a system without being sent to the zinc-containing aqueous-solution generating step and the electrolyzing step while the electric arc furnace dust or the secondary dust from which the chlorine components have been separated is sent to the zinc-containing aqueous-solution generating step.

2. (canceled)

3. (canceled)

4. The zinc production method according to claim 1, wherein
the tailing electrolyte is returned to the chlorine-concentration adjusting step and the alkali hydroxide aqueous solution in the chlorine-concentration adjusting step contains the tailing electrolyte, and
the pH value of the slurry dust obtained by agitation in a state immersed in the alkali hydroxide aqueous solution containing the tailing electrolyte is adjusted in the chlorine-concentration adjusting step.

5. The zinc production method according to claim 1, wherein a predetermined value in the range not less than 8.5 and not more than 10.5 smaller than the pH value of the alkali hydroxide aqueous solution used in the zinc-containing aqueous-solution generating step is set as a target value, and an amount of an alkali agent and an amount of water for obtaining the alkali hydroxide aqueous solution in the chlorine-concentration adjusting step are controlled according to a deviation between the target value and a measured value of the pH value of the slurry dust in the chlorine-concentration adjusting step.

6. The zinc production method according to claim 1, wherein the chlorine components are separated by bringing an antichlor in contact with the zinc-containing aqueous solution in the chlorine-concentration adjusting step.

7. The zinc production method according to claim 1, wherein
a substituting step of bringing metallic zinc in contact with the zinc-containing aqueous solution generated in the zinc-containing aqueous-solution generating step to reduce and deposit metallic impurity components that are more precious than zinc in the zinc-containing aqueous solution is further included, and
electrolysis using the zinc-containing aqueous solution having passed through the substituting step as the electrolyte is performed in the electrolyzing step.

8. The zinc production method according to claim 1, wherein
a deironizing and demanganizing step of bringing an oxidant in contact with the zinc-containing aqueous solution generated in the zinc-containing aqueous-solution generating step to separate iron components and manganese components in the zinc-containing aqueous solution, and
a substituting step of bringing metallic zinc in contact with the zinc-containing aqueous solution having passed through the deironizing and demanganizing step to reduce and deposit metallic impurity components that are more precious than zinc in the zinc-containing aqueous solution are further included, and
electrolysis using the zinc-containing aqueous solution having passed through the substituting step as the electrolyte is performed in the electrolyzing step.

9. The zinc production method according to claim 1, wherein a first zinc-containing aqueous solution, and a second zinc-containing aqueous solution having a lower chlorine concentration than that of the first zinc-containing aqueous solution are generated as the zinc-containing aqueous solution generated in the zinc-containing aqueous-solution generating step, and zinc generated by performing electrolysis using the first zinc-containing aqueous solution as an electrolyte in the electrolyzing step is used as the metallic zinc in the substituting step.
